(19) United States
(12) Patent Application Publication
(10) Pub. No.: US 2005/0224156 A1
(43) Pub. Date: Oct. 13, 2005

(54) Method of manufacturing display device and substrate bonding apparatus

(75) Inventor: Hideaki Miyazawa, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/092,733

(22) Filed: Mar. 30, 2005

(30) Foreign Application Priority Data
Apr. 13, 2004 (JP) 2004-117876

(51) Int. Cl. B32B 31/16; B32B 31/00

(52) U.S. Cl. 156/73.6; 156/539; 156/580; 156/350

(57) ABSTRACT

To provide a display device manufacturing method capable of rapidly and reliably bonding a plurality of display elements arranged in plan view to a substrate to manufacture a high-quality display device with high yield. A display device manufacturing method of the present invention comprises a step of applying an adhesive forming an adhesive layer on at least one of bonding surfaces of a display panel and a substrate, a step of bring the edge of one side of a bonding surface of the display panel into contact with a bonding surface of the substrate so that the display panel and the substrate are arranged opposite to each other substantially in a wedge shape in side view, and a step of making the substrate approach the display panel while maintaining the arrangement of the wedge shape and of bonding the substrate to the display panel while spreading the adhesive by the bonding surfaces.

### BACKGROUND

The present invention relates to a method of manufacturing a display device and to a substrate bonding apparatus.

In recent years, a much attention has been paid to an organic electroluminescent (EL) display device using organic EL elements, which are self-emission element, without requiring an external light source, such as a backlight. The organic EL elements have an advantage of displaying full colors with high quality.

In the field of electro-optical devices including the organic EL display device, there has been much progress in the devices with respect to precision and scale. Particularly, for the liquid crystal display devices or plasma display devices, large-scale display devices having about 30 to 60 inch screen have been put to a wide practical use. However, for the organic EL display device having a large-scale display screen has not yet been achieved. This is because the large scaling of a single panel of the organic EL display device has a problem with regard to mechanical strength and driving power.

Accordingly, it has been attempted to realize an organic EL display device having a large screen obtained by arranging a plurality of organic EL display panels in the form of a tile (for example, see Patent Document 1). When the plurality of display panels is arranged in the form of a tile to form a large display device, the structure in which the arranged display panels are bonded to and supported on one supporting substrate is employed. With regard to such a panel supporting structure, Patent Document 1 discloses very little information, but Patent Document 2 discloses a bonding method in which, when display panels are bonded to a supporting substrate, the support substrate is bent toward the display panels by a plurality of vacuum chucks adsorbing the support substrate and is then bonded to the arranged display panels while controlling the contact position of the support substrate with an adhesive applied on the arranged display panels.

[Patent Document 1] Japanese Unexamined Patent Application Publication No. 2001-92389

[Patent Document 2] U.S. Pat. No. 6,459,462

However, the bonding method of Patent Document 2 has the following problems. First, since it is necessary to increase the size of the supporting substrate with an increase in the number of vacuum chucks, equipment costs increase for the large scaling of a bonding apparatus. Second, since it is difficult to control the connection portions between vacuum chucks, air bubbles are apt to permeate into the adhesive between the arranged display panels and the support substrate. Further, since the vacuum chucks are densely arranged on the backside of the supporting substrate, it is very difficult to detect and remove the air bubbles in the adhesive.

In consideration of the above problems of the conventional techniques, it is an object of the present invention to provide a method of manufacturing a display device capable of rapidly and reliably bonding a plurality of display panels arranged in plan view to a supporting substrate, thereby increasing the yield of the display device with high quality. It is another object of the present invention to provide a substrate bonding apparatus having a simple structure, capable of rapidly and reliably performing a substrate bonding process and of being suitably used for the method of manufacturing a display device.

### SUMMARY

In order to achieve the above-mentioned objects, the present invention provides a method of manufacturing a display device including a display panel and a substrate arranged opposite to the display panel with an adhesive layer interposed therebetween, the method comprising: a step of applying an adhesive constituting the adhesive layer on a bonding surface of the display panel and/or on a bonding surface of the substrate; a step of bringing the edge of one side of the bonding surface of the display panel into contact with the bonding surface of the substrate so that the display panel and the substrate are arranged opposite to each other; and a step of making the substrate approach the display panel 120 while maintaining the arrangement and of bonding the substrate to the display panel while spreading the adhesive by the bonding surfaces.

In the method of manufacturing a display device according to the present invention, preferably, the display panel is composed of an arrangement panel formed by arranging a plurality of display elements in plan view, and the substrate is a substrate for supporting the display panel composed of the plurality of display elements. Here, a plurality of display panels may be arranged in plan view after forming both pixel switching elements and organic EL elements. Further, after the pixel switching elements are formed as the display panels, the plurality of display panels may be arranged in plan view, and then the organic EL elements may be formed on the plurality of display panels.

In the method of manufacturing a display device according to the present invention, preferably, the display panel includes organic EL elements, each having an organic functional layer including a light emitting layer interposed between a pair of electrodes, and the substrate is bonded to the display panel by the adhesive so as to cover the organic EL elements. Here, the substrate may be a protective substrate for giving a mechanical strength or a sealing substrate having a gas barrier property for preventing water or oxygen from being permeating into the organic EL elements from the outside. In addition, the adhesive may include fillers having a gas barrier property, similar to the sealing substrate. Since a sealing layer can be formed at the same time when the substrate is bonded in the organic EL display device, it is possible to efficiently manufacture the organic EL display device.

In the above-mentioned manufacturing method, the display panel and the substrate are arranged substantially in a wedge shape (a ‘V’ shape or a ‘<’ shape) in side view where the edge of one side of a bonding surface of the display panel comes into contact with a bonding surface of the substrate. The substrate approaches the display panel while maintaining such arrangement, and the substrate is bonded to the display panel while spreading the adhesive disposed between the display panel and the substrate. In this way, while maintaining a state in which the substrate and the display panel are arranged substantially in the wedge shape, the bonding between the substrate and the display panel is performed by spreading the adhesive from the contact position between the substrate and the display panel toward the edge opposite to the contact position, so that the adhesive is mainly spread in one way. Accordingly, it is difficult for air bubbles to be generated in the adhesive, which makes it possible to improve the yield of a display device. Particularly, in the case in which light from the display panel is emitted from the substrate, it is difficult for air bubbles to be generated. Therefore, light reflection due to the air bubbles can be prevented, and thus it is possible to realize uniform display. In addition, if the substrate is a sealing substrate, the gas barrier property can be improved since it is difficult for air bubble to be generated.

If the substrate is transparent, it is possible to rapidly and easily observe air bubbles generated in the adhesive and hence to remove them using various means. In addition, in the manufacturing method of the present invention, since it is not necessary to bend the substrate when the substrate is bonded to the display panel, the gap between the substrate and the display panel can be easily controlled. Accordingly, the expansion of the adhesive between the substrate and the display panel can be also easily controlled.

In the method of manufacturing a display device according to the present invention, when the substrate is bonded to the display panel, preferably, the substrate is arranged opposite to the display panel with the bonding surface of the display panel facing upward, and the substrate is bonded to the display panel by spreading the adhesive by inclining the substrate to the display panel. That is, in the manufacturing method of the present invention, preferably, the display panel is disposed downward, and the substrate is disposed opposite to the display panel and is then bonded to the display panel. Accordingly, since the display panel is stably supported, the manufacturing method of the present invention has an advantage of preventing the damage of the display panel provided with semiconductor elements and of easily bonding the display panel to the substrate.

In the method of manufacturing a display device according to the present invention, when the substrate is bonded to the display panel, preferably, the position of the substrate is restrained in the surface direction of the substrate at an edge of the substrate in the vicinity of a contact position between the substrate and the display panel. According to this manufacturing method, since the position of the substrate inclined with respect to the display panel is restrained in the surface direction of the substrate, the position of the substrate with respect to the display panel is accurately determined in plan view. Also, since a positional deviation does not occur in the bonding operation, the display device can be manufactured with high yield.

In the method of manufacturing a display device according to the present invention, when the substrate is bonded to the display panel, preferably, the position of the substrate is restrained at the edges of a plurality of sides of the substrate. According to this manufacturing method, since the movement of the substrate can be more effectively restricted in the surface direction, the positional alignment between the substrate and the display panel becomes more precise.

In the method of manufacturing a display device according to the present invention, when the substrate is bonded to the display panel, preferably the adhesive is spread by the weight of the substrate. According to this configuration, since stress is not applied to the substrate or a portion of the substrate that has been already bonded during the manufacturing process, the substrate is not easily damaged, and the expansion of the adhesive according to the movement of the substrate can be easily controlled. Accordingly, the bonding operation can be performed in a state in which air bubbles are hardly generated in the adhesive, and the air bubbles can be easily and rapidly removed even when the air bubbles are generated in the adhesive.

In the method of manufacturing a display device according to the present invention, when the substrate is bonded to the display panel, preferably, air bubbles generated between the substrate and the adhesive or between the display panel and the adhesive are removed by vibrating the substrate or the display panel. In this manufacturing method, since the air bubbles generated in the adhesive can be moved to the outside of the adhesive by vibrating the substrate, the air bubbles can be very easily removed, making it possible to manufacture a display device with high yield. In addition, the substrate is arranged opposite to the display panel, with the substrate inclined with respect to the display panel, and the substrate is then bonded to the display panel. Then, the air bubbles moving in the adhesive by vibrating the substrate is moved upward along the bonding surface of the substrate and is then discharged to the outside of the adhesive. Thus, it is possible to more effectively remove air bubbles.

In the manufacturing method of the display device according to the present invention, when the air bubbles are removed by vibration, the bonding operation between the substrate and the display panel may be stopped. In addition, when the air bubbles are removed by vibration, the gap between the substrate and the display panel may be widened. When this manufacturing method is used, the air bubbles in the adhesive can be efficiently and reliably removed, thereby improving manufacture yield.

Further, the present invention provides a substrate bonding apparatus used for manufacturing a display device including a first substrate and a second substrate opposite to each other with an adhesive layer interposed therebetween, comprising: substrate fixing means for fixing and holding the first substrate; substrate supporting means for cantilever-supporting the second substrate in a state in which a bonding surface of the second substrate comes into contact with the edge of one side of the first substrate; and control means for making the second substrate approach and bond to the first substrate, which is arranged opposite to each other with an adhesive interposed therebetween, by moving the substrate supporting means.

According to this substrate bonding apparatus, since the first substrate and the second substrate are arranged substantially in a wedge shape (a ‘V’ shape or a ‘<’ shape) in side view and are then boned to each other, the adhesive is spread substantially in one way between both substrates. Accordingly, it is difficult for air bubbles to be generated in the adhesive in the bonding operation. Thus, it is possible to perform a bonding operation between the substrates with high yield.

Furthermore, preferably, the substrate bonding apparatus of the present invention further comprises adhesive supplying means for applying an adhesive to form the adhesive layer on a bonding surface of the first substrate or the bonding surface of the second substrate. According to this configuration, since an adhesive applying process in substrate bonding can be performed by the substrate bonding apparatus, the substrate bonding process can be more efficiently performed.

Preferably, the substrate supporting means includes supporting rollers for supporting the bonding surface of the second substrate to slide thereon. According to this configuration, since the bonding operation is performed in a state where the bonding surface, that is, the lower surface of the second substrate is supported, the second substrate is not bent or does not press the first substrate in the bonding operation. Accordingly, without a difficulty in controlling the gap between the first substrate and the second substrate, such as the bending of the second substrate, or without easily damaging the substrates, the expansion of the adhesive between both substrates can be easily controlled. Accordingly, the substrate bonding can be precisely and easily performed.

Preferably, the substrate bonding apparatus according to the present invention further comprises substrate position restricting means arranged in the vicinity of a position where the second substrate comes into contact with the first substrate for restricting the movement of the second substrate in the surface direction thereof. According to this configuration, the positional alignment between the first substrate and the second substrate can be precisely performed by the substrate position restricting means. In addition, it is possible to prevent the positional misalignment of the second substrate when the second substrate is inclined to the first substrate.

Preferably, the substrate bonding apparatus according to the present invention further comprises vibration generating means for vibrating the first substrate or the second substrate. According to this configuration, by vibrating the substrate using the vibration generating means, the air bubbles generated in the adhesive in the substrate bonding may be discharged to the outside of the adhesive, thereby enhancing the yield of a substrate bonding operation.

Preferably, the substrate bonding apparatus according to the present invention further comprises air bubble detecting means provided on an outer surface of the first substrate or the second substrate for detecting air bubbles in the adhesive. In this configuration, preferably, the vibration generating means is operated based on air bubble information inputted from the air bubble detecting means.

By providing the air bubble detecting means, it is possible to rapidly detect and remove the air bubbles generated in the adhesive. In addition, when the vibration generating means interlocks with the air bubble detecting means, a process from the detection of air bubbles to the removal of air bubbles due to the vibration of the substrate can be automatized. This is very advantageous when bonding a great quantity of substrates.

In the substrate bonding apparatus according to the present invention, preferably, the substrate supporting means operates based on air bubble information inputted from the air bubble detecting means. According to this configuration, the substrate bonding operation interlocks with the air bubbles detecting operation by the air bubble detecting means. Therefore, for example, if air bubbles are generated, the substrate bonding operation may be temporarily stopped to remove the air bubbles during the stop. Accordingly, it is possible to very efficiently perform a substrate bonding operation with high yield.

In the substrate bonding apparatus according to the present invention, the first substrate may be a display panel composed of a plurality of display elements arranged in plan view, and the second substrate may be a substrate for integrally supporting the display panel. That is, the substrate bonding apparatus of the present invention can be suitably used for manufacturing a display device having a large display region by arranging the plurality of display elements in plan view.

### BRIEF DESCRIPTION OF THE DRAWINGS

FIG. 1 is a perspective view of an EL display device according to an embodiment of the present invention;

FIGS. 2A and 2B are a plan view and a side view of a display device according to the embodiment of the present invention, respectively;

FIGS. 3A and 3B are a plan view and a cross-sectional view of a manufacturing apparatus according to the embodiment of the present invention;

FIG. 4 is a cross-sectional view illustrating a manufacturing process according the embodiment of the present invention;

FIG. 5 is a cross-sectional view illustrating another embodiment of the manufacturing apparatus;

FIG. 6 is a circuit diagram of a display panel according to an embodiment of the present invention;

FIGS. 7A and 7B are plan views illustrating a pixel portion of the display panel;

FIG. 8 is a cross-sectional view taken along the line B-B′ of FIG. 7;

FIG. 9 is an exploded perspective of a droplet discharging head; and

FIG. 10 is a perspective view illustrating a main portion of the droplet discharging head.

### DETAILED DESCRIPTION OF EMBODIMENTS

Hereinafter, preferred embodiments of the present invention will be described with reference to the accompanying drawings. In all figures, dimensions of elements are adequately scaled for the purpose of easily viewing the figures.

(EL Display Device)

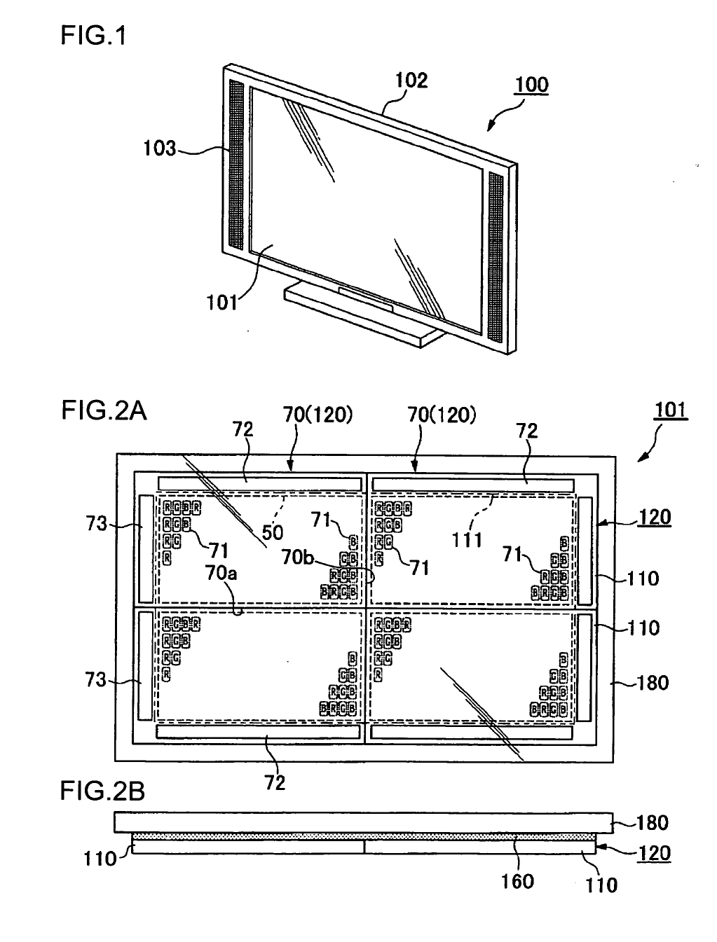

FIG. 1 is a perspective view of a large EL display device having a display device according to the present invention. An EL display device 100 includes a display unit 101 employing a display device of the present invention as a main body, a case 102, and a speaker 103.

FIGS. 2A and 2B are plan and side views of the display unit 101 shown in FIG. 1, respectively. As shown in FIG. 2, the display unit 101 mainly includes a display panel (arrangement panel) 120 having a plurality (4 in the figure) of display elements 70 arranged in the form of a tile and a substrate 180 bonded to the display panel 120 via an adhesive layer 160. Each display element 70 includes an element substrate 110, a display region 50 provided on the element substrate 110, and driving circuits 72 and 73 provided around the display region 50. A plurality of pixels 71 is arranged in a matrix in plan view. Each pixel 71 includes an organic EL element, which will be described later, and emits light obtained by the luminescence of the organic EL element as light for display.

In addition, the display elements 70 are arranged with that their display regions 50 in contact with each other, and an image display portion 111 of the display unit 101 is defined by four display regions 50. The driving circuits 72 and 73 are arranged around the image display portion 111.

In addition, in FIG. 2A, although regions near the boundaries 70a and 70b between the display elements 70 are shown to be wide for the purpose of easy view of the figure, in actuality, a space between adjacent pixels 71 and 71 with the boundaries 70a and 70b interposed therebetween is very narrow. If necessary, the boundaries may be subjected to a process for concealing them, such as a light shielding process.

In addition, although each display element 70 is provided with the driving circuits 72 and 73 in the present embodiment, it is possible to drive the plurality of pixels 71 by fewer driving circuits by connecting wiring lines of the display elements 70 at the boundaries 70a and 70b therebetween.

In addition, the display regions 50 and the driving circuits 72 and 73 of the display elements 70 are provided on a surface of the substrate 110 facing the adhesive layer 160, and light emitted from the organic EL element is emitted from the upper side of FIG. 2B through the adhesive 150 and the substrate 180. That is, each display element 70 according to the present embodiment is a top emission type organic EL display panel.

Since the substrate 180 is a transparent substrate for integrally supporting the four display elements 70 and constitutes the outermost surface of the display unit 101, it is preferable that the substrate 180 have properties of pressure resistant, wear resistant, gas barrier, ultraviolet ray absorption, low reflectance, etc. As the substrate 180 having these properties, a glass substrate or a plastic film with its outermost surface coated with a diamond-like carbon (DLC) layer, a silicon oxide layer, a titanium oxide layer, etc., is preferably used.

In addition, the substrate 180 is formed of a transparent substrate since display light is emitted from the substrate 180 in the present embodiment. However, it should be understood that the substrate 180 might be formed of an opaque substrate in a case in which the display unit 101 is configured such that the display light is emitted from the device substrate 110.

(Manufacturing Method of Display Device)

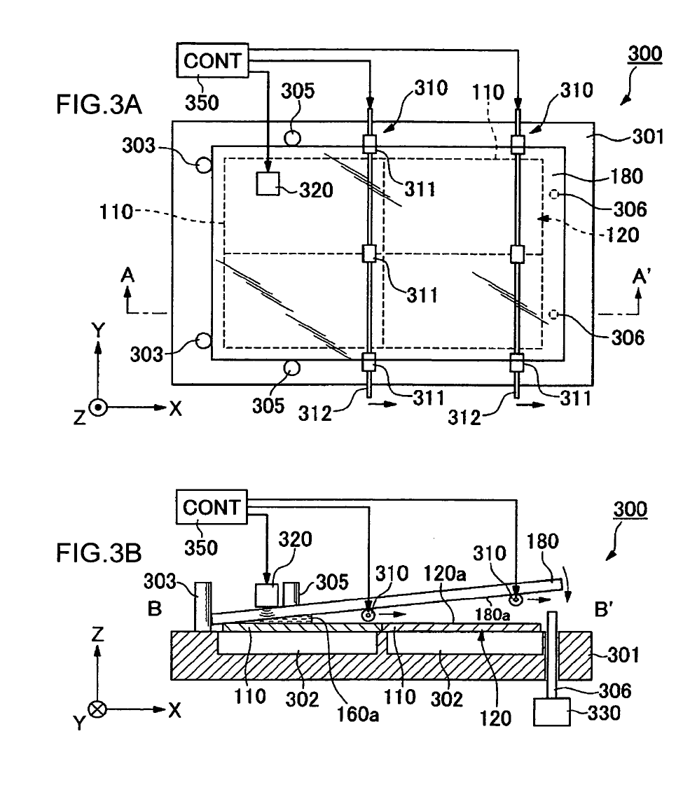

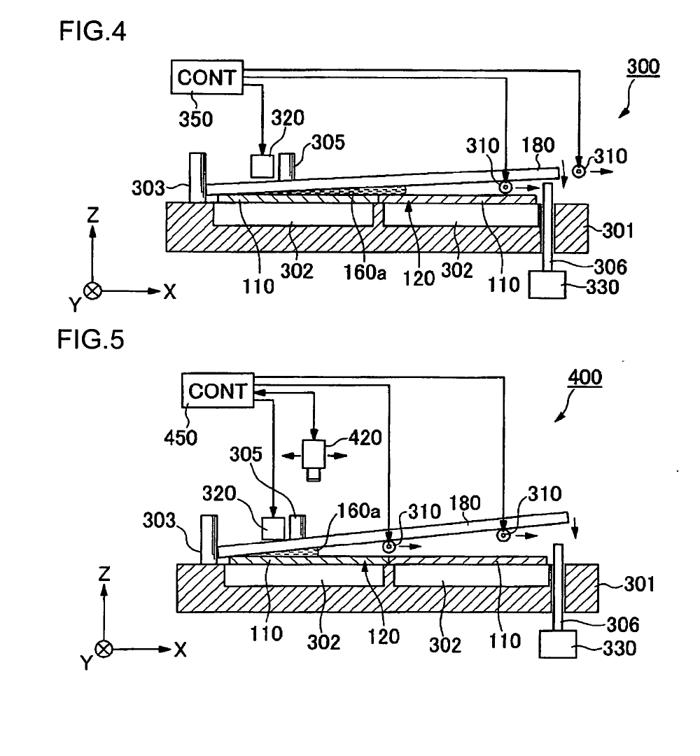

Next, a manufacturing method of the display unit 101 shown in FIG. 2 will be described with reference to FIGS. 3 and 4. FIG. 3A is a plan view of a substrate bonding apparatus used in the manufacturing method, and FIG. 3B is a sectional view taken along the line A-A′ of FIG. 3A. FIG. 4 is a sectional view illustrating the manufacturing method of the display unit 101, which corresponds to FIG. 3B.

<Substrate Bonding Apparatus>

First, a substrate bonding apparatus 300, which can be suitably used for manufacturing the display unit 101, will be described. As shown in FIG. 3, the substrate bonding apparatus 300 includes a base 301 on which the display panel (first substrate) 120 is mounted and fixed, a plurality of substrate supporting means 310 for supporting the substrate (second substrate) 180 on the display panel 120, vibration generating means 320 for vibrating the substrate 180, and a control unit (control means) 350 connected to the substrate supporting means 310 and the vibration generating means 320 for controlling these means.

As shown in FIG. 3B, the display panel 120 is arranged opposite to the substrate 180 in a wedge shape when viewed from side on the substrate bonding apparatus 300, and then, the substrate bonding apparatus 300 performs a bonding process by spreading an adhesive 160a interposed between the display panel 120 and the substrate 180 to their bonding surfaces 120a and 180a.

The base 301 has adsorption chucks (substrate fixing means) 302 arranged on a mount surface (top side in the figure) on which the display panel 120 is mounted, and four positioning pins (substrate position defining means) 303 and 305 are provided perpendicular to the mount face in the vicinity of the adsorption chucks 302.

In addition, two supporting pins 306 and 306 are arranged on the opposite side of the positioning pins 303 with the display panel 120 placed therebetween. Each of the supporting pins 306 penetrates the base 301 in the Z direction shown in FIG. 3B, and its one end projects toward the backside (bottom in FIG. 3B) of the base 301 and is connected to supporting pin driving means 330. Although not shown, the supporting pin driving means 330 is connected to the control unit 350 in the same way as the substrate supporting means 310. The supporting pin driving means 330 allows the supporting pins 306 and 306 to forward or backward move in the Z direction based on a driving control signal supplied from the control unit 350.

The adsorption chucks 302 fix the display panel 120 at a predetermined position on the base 301 by, for example, vacuum adsorption or electrostatic adsorption and are provided corresponding to the respective element substrates 110 (the display elements 70) constituting the display panel 120. In addition, the shape of the adsorption chucks 302 is not limited to the adsorption methods as mentioned above.

The positioning pins 303 and 305 serve to support the substrate 180 at a predetermined position in cooperation with the substrate supporting means 310, which will be described later. The positioning pins 303 come into contact with an end of a side extending in the Y direction of the rectangular substrate 180 in plan view and restrict the movement of the substrate 180 in the X direction, and the positioning pins 305 come into contact with ends of two sides extending in the X direction of the rectangular substrate 180, respectively and restrict the movement of the substrate in the Y direction.

Each substrate supporting means 310 has three supporting rollers 311 and a supporting shaft 312 for rotatably supporting these supporting rollers 311 at a coaxial position and is configured such that the supporting shaft 312 is horizontally movable in the X direction based on a driving control signal supplied from the control unit 310. As shown in FIG. 3B, the substrate supporting means 310 support the substrate 180, with a contact position between the display panel 120 and the substrate 180 as a fulcrum, in a state in which the substrate 180 is inclined with respect to the base 301. In addition, the supporting shafts 312 of two substrate supporting means 310 are movable independently or interlockingly.

The vibration generating means 320 is arranged on the substrate 180 (on the opposite side of the base 301), as shown in FIG. 3B, and serves to vibrate the substrate 180 based on the driving control signal supplied from the control unit 350. Even when air bubbles are generated in the adhesive 160a at the time when the substrate 180 is bonded to the display panel 120, the vibration generating means 320 enables the air bubbles to be discharged to the outer side of the adhesive 160a by vibration.

In addition, the vibration generating means 320 is not particularly limited to its shape and may be of any shape. One example of the vibration generating means 320 having the simplest structure may include a vibration generating device having a rod-shaped member and a driving unit for moving the rod-shaped member in the longitudinal direction thereof. As shown in FIG. 3B, the vibration generating device is arranged on the substrate 180 and can vibrate the substrate 180 and the display panel 120 by colliding the rod-shaped member with the substrate 180 while moving the rod-shaped member toward the substrate 180.

<Manufacturing Process of Display Device>

Next, a manufacturing process of the display unit 101 using the substrate bonding apparatus 300 will be described with reference to FIGS. 3 and 4.

In order to bond the substrate 180 to the display panel 120 using the substrate bonding apparatus 300 according to the present embodiment having the above-mentioned configuration, first, as shown in FIG. 3B, the element substrates 110 (display elements 70) are arranged at predetermined positions on the base 301 and then fixed by the adsorption chucks 302 to form the display panel 120.

Next, the adhesive 160a for forming the adhesive layer 160 shown in FIG. 2 is applied to the bonding surface 120a of the display panel 120 mounted on the base 301. The adhesive 160a is made of, for example, a transparent resin material, such as an acryl resin, and its concentration or viscosity is properly set depending on materials of the display panel 120 and the substrate 180 used for bonding.

Thereafter, the substrate 180 is loaded on the supporting rollers 311 of the substrate support means 310 such that the substrate 180 is opposite to the display panel 120 fixed on the base 301. At this time, the edge of the display panel 120 at the side of the positioning pin 303 comes into contact with the bonding surface 180a of the substrate 180, and the positioning pins 303 and 303 come into contact with the edge of the substrate 180, such that the display panel 120 and the substrate 180 are arranged in the form of a wedge in side view.

In addition, after the display panel 120, the adhesive 160a, and the substrate 180 are arranged at predetermined positions, the control unit 350 drives the substrate supporting means 310 to move the supporting shaft 312 in the right direction (the X direction) of the figure. Then, the supporting rollers 311 of the substrate supporting means 310 slide on the bonding surface 180a of the substrate 180, and accordingly, the substrate 180 which is cantilever-supported by the substrate supporting means 310 is inclined toward the display panel 120, as shown in FIG. 4. Accordingly, the adhesive 160a interposed between the substrate 180 and the display panel 120 is pressed and spread over the bonding surfaces 120a and 180a by the substrate 180. At this time, the substrate 180 is inclined with the contact point between the substrate 180 and the display panel 120 as a fulcrum. However, since the position of the substrate 180 is restrained in the X and Y directions by the positioning pins 303 and 305, the substrate 180 is moved to be covered on the display panel 120 while maintaining the positional relation with the display panel 120 in the surface direction.

In addition, the movement speed of the substrate supporting means 310 is adjusted according to the state of the adhesive 160a pressed and spread by the substrate 180. For example, the movement speed of the supporting rollers 311 is adjusted to be substantially equal to the expansion speed of the adhesive 160a.

Here, air bubbles may be generated in the adhesive 160a when the substrate 180 is bonded to the display panel 120. When the air bubbles are generated, the control unit 350 actuates the vibration generating means 320 to vibrate the substrate 180 (see FIG. 3B). Then, the air bubbles in the adhesive 160a are discharged to the outside of the adhesive 160a. In the present embodiment, since the adsorption chucks and so on are not arranged on the transparent substrate 180, the presence of the air bubbles can be easily confirmed by the naked eye even when the air bubbles are present in the adhesive 160a. Accordingly, it is possible to immediately cope with the generation of air bubbles, and thus the bonding of the substrate can be performed with high yield.

In addition, in the substrate bonding apparatus 300 according to the present invention, the substrate 180 is inclined with respect to the base 301 during the bonding operation. Therefore, when the air bubbles in the adhesive 160a are removed, air bubbles can be more efficiently removed since the air bubbles began to move by the generated vibration and are then escaped upward along the bonding surface 180a of the substrate 180.

In addition, in interlock with the operation of the vibration generating means 320, the operation of the substrate supporting means 310 can be changed. For example, it may be configured that, when the air bubbles are detected and the vibration generating means 320 is actuated, the movement of the substrate supporting means 310 is stopped for a predetermined time and is then resumed in the X direction of the substrate supporting means 310 after the air bubbles are removed. In addition, the vibration generating means 320 is driven, and the substrate supporting means 310 is moved by a certain distance in the opposite direction (on the side of the positioning pins 303) to widen a space between the substrate 180 and the display panel 120. Accordingly, the adhesive 160a can be controlled to retreat to an end side of the base (to the positioning pins 303) in order to promote the removal of the air bubbles.

When the inclination operation of the substrate 180 continues, as shown in FIG. 4, the substrate supporting means 310 in the progressing direction of two substrate supporting means 310 deviates from the bonding surface 180a of the substrate 180, and the substrate 180 keeps supported by the edge of the display panel 120 and one substrate supporting means 310. In addition, when the substrate supporting means 310 continue to move, the remaining substrate supporting means 310 also deviates from the bonding surface 180a of the substrate 180. When the remaining substrate supporting means 310 is separated from the bonding surface 180a, in the substrate bonding apparatus 300 of the present embodiment, the substrate 180 touches the supporting pins 306 projecting from the base 301 and keeps supported by the display panel 120 and the supporting pins 306. When the supporting pins 306 are retreated by means of the supporting pin driving means 330 to incline the substrate 180 up to a position in substantially parallel to the display panel 120, the bonding between the substrate 180 and the display panel 120 is completed.

Thereafter, if necessary, by hardening the adhesive 160a, it is possible to manufacture the display unit 101 in which the substrate 180 is bonded to the display panel 120 with the adhesive layer 160 interposed therebetween.

In this way, when the substrate 180 is bonded to the display panel 120 using the substrate bonding apparatus 300 according to the present embodiment, both can be bonded to each other at an accurate position without generating air bubbles in the adhesive 160a. In addition, even when the air bubbles are generated in the adhesive 160a, the air bubbles can be removed by the vibration generating means 320. Therefore, it is possible to efficiently manufacture the display unit 101 with high yield.

As a conventional substrate bonding method, there is a method in which one substrate is bent and bonded to another substrate (for example, see Patent Document 2). In the case in which the substrate is bent to press an adhesive, there is a need to properly adjust the bending width of the substrate such that the substrate is not damaged. In addition, since the bending width of the substrate is not uniform in the surface direction, there is a need to minutely control a gap between the substrates to be bonded to each other in order to stably perform the bonding operation. Further, if the bonding speed is not precisely controlled, a problem arises in that air bubbles are apt to be generated in the adhesive.

On the contrary, in the manufacturing method according to the present invention, since the substrate 180 is cantilever-supported by the substrate supporting means 310, the substrate 180 is bonded to the display panel 120 via the adhesive 160a spread by the weight of the substrate 180 without being pressed or bent against the display panel 120. Accordingly, the bonding operation can be performed while controlling the expansion state of the adhesive 160a so as not to generate air bubbles, without generating the damage of the substrate 180 caused by the bending of the substrate 180.

<Another Embodiment of Substrate Bonding Apparatus>

The substrate bonding apparatus according to the present invention may include a substrate bonding apparatus as shown in FIG. 5. Hereinafter, the substrate bonding apparatus shown in FIG. 5 will be described.

FIG. 5 is a sectional view of another embodiment of the substrate bonding apparatus according to the present invention, which corresponds to the sectional view taken along the line A-A′ of FIG. 3A. In FIG. 5, elements having the same reference numerals as those in FIG. 3 are the same elements as those in the above-described embodiment, and thus a detailed explanation thereof will be omitted.

A substrate bonding apparatus 400 according to the present embodiment shown in FIG. 5 is characterized in that it includes optical measurement means 420 for measuring the state of the adhesive 160a from the substrate 180 and a control unit 450 for controlling the driving of the optical measurement means 420. The control unit 450 is connected to the substrate supporting means 310, the vibration generating means 320, and the supporting pin driving means 330 for controlling the driving of these elements, and also serves to control the bonding between the substrate 180 and the display panel 120.

The optical measurement means 420 formed of, for example, a video camera serves to photograph the adhesive 160a through the transparent substrate 180. The control unit 450 connected to the optical measurement means 420 processes an image of the adhesive 160a acquired by the optical measurement means 420 and determines the presence of air bubbles in the adhesive 160 based on the processed image. Accordingly, the optical measurement means 420 and the control unit 450 constitute air bubble detecting means according to the present invention.

Under the above configuration of the substrate bonding apparatus 400 according to the present embodiment, when the control unit 450 detects the generation of air bubbles based on image information acquired by the optical measurement means 420 at the time when the substrate 180 is bonded to the display panel 120, the control unit 450 outputs a driving signal to the vibration generating means 320 to actuate the vibration generating means 320, thereby vibrating the substrate 180. Accordingly, the air bubbles are removed from the adhesive 160a by the vibration, so that a good bonding between the substrate 180 and the display panel 120 is attained.

According to the present embodiment, since the air bubbles in the adhesive 160a can be automatically detected and removed at the time when the substrate 180 is bonded to the display panel 120, the bonding operation can be very efficiently performed with high yield.

In the configuration shown in FIG. 5, the optical measurement means 420 is movable in the X direction in conformity with the operation of the substrate supporting means 310 and can constantly observe a leading end in the progressing direction of the adhesive 160a spread on the display panel 120 according to the operation of the substrate supporting means 310. Accordingly, the detection of the air bubbles in the adhesive 160a can be precisely and quickly performed.

In addition, in the configuration shown in FIG. 5, when the vibration generating means 320 and the substrate supporting means 310 are controlled to operate interlockingly, similar to the above-mentioned embodiment, the removal efficiency of the air bubbles can be enhanced to attain high yield.

(Detailed Configuration of Display Panel)

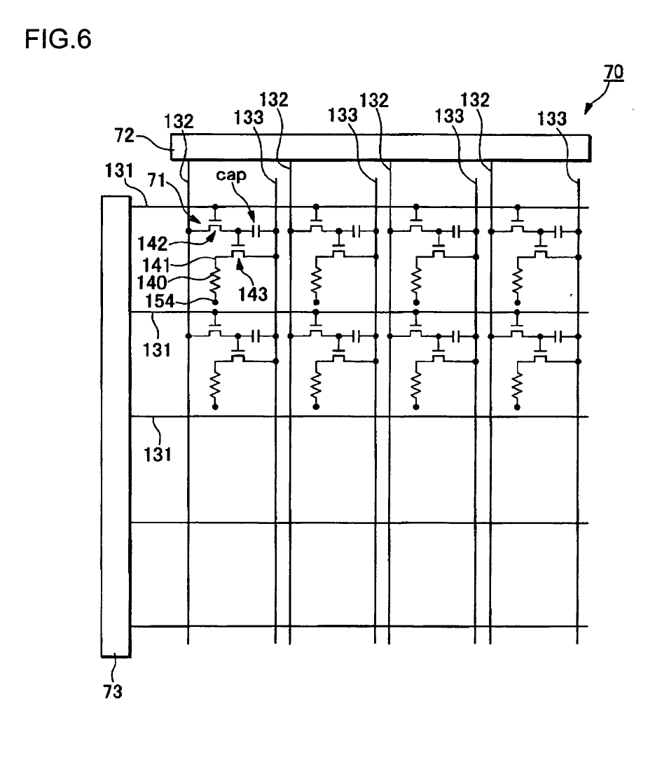

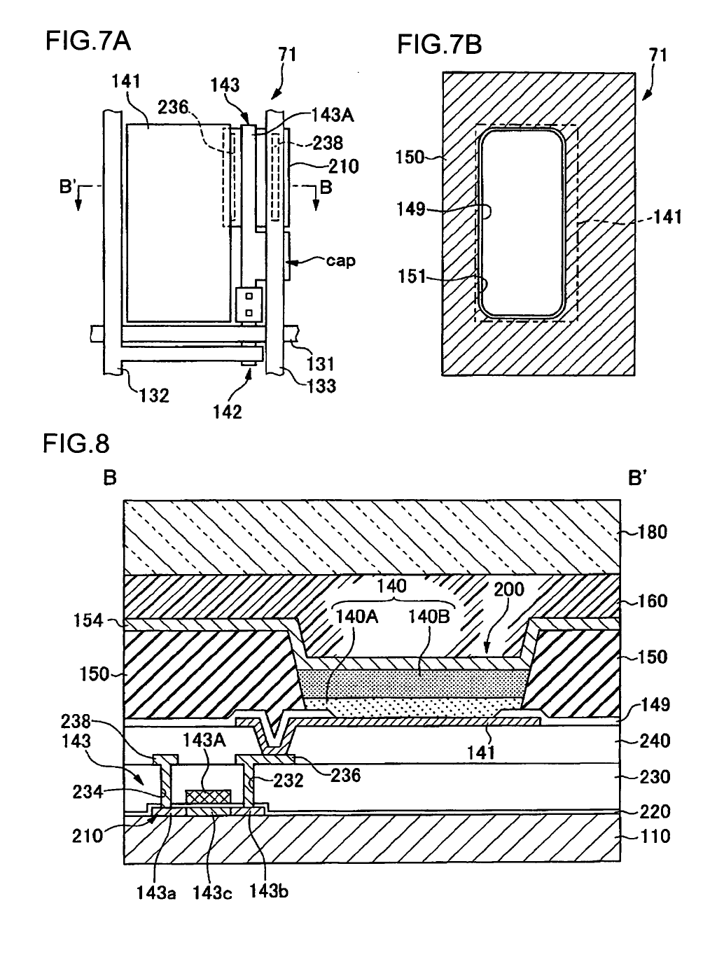

Next, the detailed configuration of each display element 70 constituting the display unit 101 will be described with reference to FIGS. 6 to 8. FIG. 6 is a circuit diagram of the display element 70, and FIGS. 7A and 7B are diagrams illustrating a planar structure of a pixel 71, where FIG. 7A is a diagram illustrating a pixel driving portion of a thin film transistor (TFT) of the pixel 71 and FIG. 7B is a diagram illustrating a bank (partition member) for partitioning pixels. FIG. 8 is a sectional view taken along the line B-B′ of FIG. 7.

In the circuit configuration as shown in FIG. 6, the display element 70 includes a plurality of scanning lines 131, a plurality of signal lines 132 extending in a direction orthogonal to the plurality of scanning lines 131, a plurality of common feeding lines 133 extending in parallel to the plurality of signal lines 132, pixels 7 respectively arranged at intersections between the plurality of scanning lines 131 and the plurality of signal lines 132.

The signal lines 132 are connected to a data line driving circuit 72 equipped with a shift register, a level shifter, a video line, an analog switch, etc. On the other hand, the scanning lines 131 are connected to a scanning line driving circuit 73 equipped with a shift register, a level shifter, etc. In addition, each pixel 71 includes a switching TFT (thin film transistor) 142 having a gate electrode supplied with a scanning signal via a scanning line 131, a storage capacitor ‘cap’ for storing an image signal supplied from the signal line 132 via the switching TFT (thin film transistor) 142, a driving TFT 143 having a gate electrode supplied with the image signal stored in the storage capacitor cap, a pixel electrode 141 into which a driving current flows from a common feeding line 133 when the pixel electrode 141 is electrically connected to the common feeding line 133 via the driving TFT 143, and a light emitting portion 140 interposed between the pixel electrode 141 and a common electrode 154. The pixel electrode 141, the common electrode 154, and the light emitting portion 140 constitute an organic EL element.

Under this configuration, when the scanning line 131 is driven to turn on the switching TFT 142, the potential of the signal line 132 is stored in the storage capacitor cap, and an on/off state of the driving TFT 143 is determined based on the state of the storage capacitor cap. In addition, when a current flows into the pixel electrode 141 from the common feeding line 133 via a channel of the driving TFT 143 and current flows to the common electrode through the light emitting portion 140, the light emitting portion 140 emits light in proportion to the amount of current flowing therethrough.

Next, as shown in the planar structure of the pixel 71 of FIG. 7A, four sides of the pixel electrode 141 of the pixel 71 having substantially a rectangular shape in plan view are surrounded by the signal line 132, the common feeding line 133, the scanning line 131, and a scanning line (not shown) for another pixel electrode. In addition, as shown in the sectional structure of the pixel 71 of FIG. 8, the driving TFT 143 is provided on the element substrate 110. In addition, an organic EL element 200 is formed on the element substrate 110 via a plurality of insulating films formed so as to cover the driving TFT 143. The organic EL element 200 is mainly composed of an organic functional layer (light emitting portion) 140 provided in a region surrounded by the bank (partition member) 150 formed on the element substrate 110. This organic functional layer is interposed between the pixel electrode 141 and the common electrode 154.

Here, as shown in the planar structure of FIG. 7B, the bank 150 has an opening 151 having substantially a rectangular shape in plan view and corresponding to a formation region of the pixel electrode 141, and the organic functional layer 140 is formed in the opening 151.

As shown in FIG. 8, the driving TFT 143 is mainly composed of a source region 143a, a drain region 143b, and channel region 143c, which are formed on a semiconductor film 210, and a gate electrode 143A opposite to the channel region 143c with a gate insulating layer 220 formed on the semiconductor film interposed therebetween. A first interlayer insulating film 230 is provided to cover the semiconductor film 210 and the gate insulating film 220, and a drain electrode 236 and a source electrode 238 are buried in contact holes 232 and 234 passing through the first interlayer insulating film 230 to reach the semiconductor film 210, respectively. The drain and source electrodes 236 and 238 is electrically connected to the drain and source regions 143b and 143a, respectively. A second interlayer insulating film 240 is formed on the first interlayer insulating film 230, and a portion of the pixel electrode 141 is buried in a contact hole passing through the second interlayer insulating film 240. In addition, as the pixel electrode 141 is electrically connected to the drain electrode 236, the driving TFT 143 is electrically connected to the pixel electrode 141 (organic EL element 200).

An inorganic bank (first partition layer) 149 made of an inorganic insulating material is formed on the second interlayer insulating film 240 and is arranged to partially beach on the edge of the pixel electrode 141. A bank (second partition layer) 15 made of an organic material is formed on the inorganic bank 149, forming a partition member for the organic EL device.

The organic EL device 200 is formed by laminating a hole injecting layer (charge transporting layer) 140A and a light emitting layer 140B on the pixel electrode 141 and by forming the common electrode 154 to cover the light emitting layer 140B and the bank 150. The hole injecting layer 140A is formed to cover the surface of the pixel electrode 141, and the edge of the hole injecting layer 140A is formed to cover a portion of the inorganic bank 149 provided at a lower side of the bank 150 to project from the bank 150 to the center of the pixel electrode 141.

As a material for forming the hole injecting layer 140A, for example, polythiophene derivatives, polypyrrole derivatives, or material obtained by doping them is used. Particularly, a dispersion solution of 3,4-polyethylenedeoxythiophene/polystylenesulfonic acid (PEDOT/PSS) and so on can be used.

As a material for forming the light emitting layer 140B, a well-known light emitting material capable of emitting fluorescence or phosphorescence can be used. Specifically, (poly) fluorine derivatives (PF), (poly)paraphenylenevinylene derivatives (PPV), polyphenylene derivatives (PP), polyparaphenylene derivatives (PPP), polyvinylcarzole (PVK), polythiophene derivatives, or a polysilane-based material, such as polymethylphenyl silane (PMPS), is suitably used.

In addition, a high molecular material doped with a pigment material, such as a phenylene pigment, coumarin pigment, or rhodamine pigment, or a low molecular material, such as rubrene, perylene, 9,10-dephenylanthracene, tetraphenylbutadiene, nylonred, coumarin 6, or quinacridone, can be used.

In addition, instead of the above-mentioned high molecular materials, a well-known low molecular material may be used. If necessary, an electron injecting layer made of metal or metal compounds containing calcium, magnesium, lithium, sodium, strontium, barium, or cesium as the main ingredient may be formed on the light emitting layer 140B.

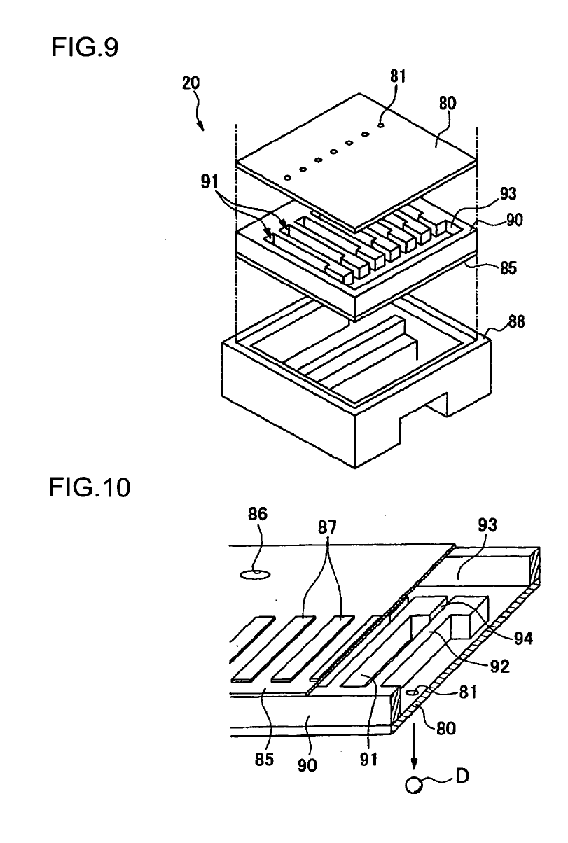

Here, a droplet discharging method is adequately used for forming the hole injecting layer 140A and the light emitting layer 140B. In this case, a droplet discharging head 20 shown as an example in FIGS. 9 and 10 may be used. FIG. 9 is an exploded perspective view of the droplet discharging head 20. The droplet discharging head 20 includes a nozzle plate 80 having a plurality of nozzles 81, a pressure chamber substrate 90 having a diaphragm 85, and a case 88 in which the nozzle plate 80 is fitted to the diaphragm 85.

As shown in a partially perspective view of FIG. 10, the main portion of the droplet discharging head 20 has a structure in which the pressure chamber substrate 90 is interposed between the nozzle plate 80 and the diaphragm 85. The nozzles 81 of the nozzle plate 80 correspond to pressure chambers (cavities) 91 formed by partitioning the pressure chamber substrate 90, respectively. The pressure chamber substrate 90 is provided with a plurality of cavities 91, each of which functions as a pressure chamber, formed by etching a silicon monocrystalline substrate. The cavities 91 are separated from one another by sidewalls 92. Each cavity 91 communicates with a reservoir 93, which is a common flow path, via a supply port 94. The diaphragm 95 is formed of, for example, a thermal oxide film.

A tank port 86 is provided in the diaphragm 85. The tank port 86 serves to supply a liquid material from the tank (not shown). Piezoelectric elements 87 are arranged at positions corresponding to the cavities 91 on the diaphragm 85. Each piezoelectric element 87 has a structure in which a crystal of piezoelectric ceramics, such as a PZT element, is interposed between upper and lower electrodes (not shown). The piezoelectric elements 87 serves to generate a volume variation in response to a discharge signal supplied from a control unit (not shown).

In order to discharge droplets from the droplet discharging head 20, a predetermined discharging signal is supplied to the piezoelectric elements 87 of the droplet discharging head 20. The droplets are introduced into the cavities 91 of the droplet discharge head 20. In the droplet discharging head 20 supplied with the discharging signal, the piezoelectric elements 87 generate the volume variation according to a voltage applied between the upper electrode and lower electrode thereof. This volume variation deforms the diaphragm 85 and accordingly changes the volumes of the cavities 91. As a result, droplets D are discharged from the nozzles 81 of the cavities 91. A liquid material lessened according to the discharge is supplemented from the reservoir 93 to the cavities 91 from which the droplets are discharged. In addition to the structure in which the droplets are discharged by generating the volume variation of the piezoelectric elements, the droplet discharging head may have a structure where a heating element heats the liquid material and the droplets are discharged by the expansion of the liquid material.

In the present embodiment, the hole injecting layer 140A and the light emitting layer 140B can be formed in the opening 151 of the bank 150 formed on the device substrate 110 by positioning the nozzle holes 81 of the droplet discharging head 20, by discharging the droplets D to dispose the liquid materials containing the material for forming the hole injecting layer or the material for forming the light emitting layer, and by drying the liquid materials.

Retuning to FIG. 8, in the case of a so-called top emission type EL display panel having the configuration in which light is emitted from the upper surface of the organic EL element 200 (the side opposite to the element substrate 110), as the element substrate 110, an opaque substrate may be used in addition to the transparent substrate made of, for example, glass. The opaque substrate may be formed by performing an insulating process, such as oxidation, on ceramics, such as alumina, or a metal sheet, such as a stainless steel, or made of a thermosetting resin or a thermoplastic resin, or a film thereof (plastic film).

The pixel electrode 141 is made of a transparent conductive material, such as an indium tin oxide (ITO) in the case of a bottom emission type in which light is emitted via the element substrate 110 in the above-mentioned embodiment. However, the pixel electrode 141 may be made of a suitable conductive material, such as a metallic material, in the case of the top emission type.

The common electrode 154 is formed on the element substrate 110 to cover top surfaces of the light emitting layer 140B and the bank 150 and sidewalls of the bank 150. As a material for forming the common electrode 154, a transparent conductive material is used in the case of the top emission. The transparent conductive material is preferably ITO, but may be of any transparent conductive material.

A cathode protecting layer may be formed on the common electrode 154. By providing the cathode protecting layer, the common electrode 154 can be prevented from being etched during the manufacturing process and can be formed of inorganic compounds including silicon compounds, such as a silicon oxide, a silicon nitride, and a silicon nitric oxide. By covering the common electrode 154 with the cathode protecting layer made of an inorganic compound, the permeation of oxygen into the common electrode 154 can be prevented. In addition, the cathode protecting layer is formed to have a thickness of about 10 nm to 300 nm.

The adhesive layer 160 is provided to cover the common electrode 154, and the substrate 180 is bonded via the adhesive layer 160. That is, in the display unit 101 of the present embodiment, the adhesive layer 160 and the substrate 180 additionally serve as a sealing member for sealing the organic EL elements 200 of the plurality of display elements 70.

When the adhesive layer 160 serves as the sealing member for sealing the organic EL elements 200, it is preferable to planarize the unevenness of the element substrate 110 due to the bank 150 surrounding the organic EL elements 200 and to make the element substrate 110 transparent. A material for forming the adhesive layer 160 preferably includes an oleophilic high molecular material (organic resin material), such as polyolefine, epoxy resin, acryl resin, silicon resin, polyurethane, polyether, or polyester. More specifically, it includes derivatives derived from a mixture and polymeriztion of acryl polyol, polyester polyol, polyether polyol, or polyurethane polyol with isocyanate compounds, such as tolylene diisocyanate or xylene diisocyanate, or derivatives derived from a mixture and polymerization of bisphenol epoxy oligomer with amine compounds. In addition, their organic compounds diluted by an oleophilic organic solvent, such as toluene, xylene, cyclohexane, methyl ethyl ketone, or acetic acid ethyl, and having certain viscosity, are applied on the display panel 120 as the adhesive 160a, as shown in FIG. 3.

In addition, as the material for forming the adhesive layer 160, an ultraviolet curable resin with methacrylate resin or epoxy resin as a main ingredient may be used. When the ultraviolet curable resin is used, the adhesive layer 160 can be formed without performing a heating process. Therefore, a bad influence of heating on the light emitting layer 140B can be prevented. In this case, it is preferable to form an ultraviolet absorption layer made of an ultraviolet absorption material between the common electrode 154 and the adhesive layer 160. For example, it is preferable to form, between the common electrode 154 and the adhesive layer 160, a layer made of an oxide semiconductor material transmitting a visible ray and having an energy band gap of more than 3 eV, such as a titanium oxide, zinc oxide, or indium tin oxide (ITO). When forming such an ultraviolet absorption layer, it is possible absorb an ultraviolet ray passing through the adhesive layer 160 and thus to prevent the ultraviolet ray irradiated to the adhesive layer 160 from making a bad influence on the light emitting layer 140B.

In addition, particles having a diameter smaller than the thickness of the adhesive layer 160, or silane compounds, such as alkoxysilane or silasane, may be added to the adhesive layer 160. The addition of the particles makes it possible to adjust the fluidity of the adhesive 160a forming the adhesive layer 160. In addition, due to the particles, since it is difficult for the adhesive layer 160 to generate a volume variation with respect to a temperature variation at the time when the adhesive 160 is hardened or used, the organic EL elements 200 have a light burden, and thus the reliability of the display unit 101 can be enhanced.

The particles added to the adhesive layer 160 preferably include an organic high molecular or inorganic oxide material, such as polyester, polystyrene, polymethyl metacrylate (PMMA), silica, or alumina. In addition, preferably, the particles are subjected to a surface process, such as a coupling process, such that they are easily soluble in the adhesive 160a. In addition, preferably, the particles have a diameter of about 10 nm to 1000 nm are added with a containing ratio of 10% to 70%. In this way, the particles fill up the step difference of the opening 151 of the bank 150, thereby forming a good layer without a gap.

In the above-mentioned embodiments, the case in which the display element 70 constituting the display unit 101 is a top emission type EL display panel has been described. However, the display element 70 may be a bottom emission type EL display panel, and other electro-optical panels, such as a liquid crystal display panel and a plasma display panel, may be used instead of the display elements 70.

In addition, in the above-mentioned embodiment, the display element 70 includes the element substrate 110 including TFTs, the display region 50 provided on the element substrate 110, and the driving circuits 72 and 73 provided around the display region 50, and the plurality of pixels 71 each including an organic EL element are arranged in a matrix in plan view. However, organic EL elements may be formed on a plurality of display panels after pixel switching elements are formed as the display panel and then the display panels are arranged in plan view.

Although the display panel 120 has been described as a display panel defined in the claims, the display panel is at least one organic EL display panel including organic EL elements each having an organic functional layer including a light emitting layer between a pair of electrodes, and the substrate may be bonded to the organic EL elements to cover them by the adhesive interposed therebetween. Here, the substrate may be a protective substrate for giving a mechanical strength or a sealing substrate having a gas barrier property for preventing water or oxygen from being permeated into the organic EL elements.

1. A method of manufacturing a display device including a display panel and a substrate arranged opposite to the display panel with an adhesive layer interposed therebetween,
the method comprising:
a step of applying an adhesive constituting the adhesive layer on a bonding surface of the display panel and/or on a bonding surface of the substrate;
a step of bringing the edge of one side of the bonding surface of the display panel into contact with the bonding surface of the substrate so that the display panel and the substrate are arranged opposite to each other; and
a step of making the substrate approach the display panel while maintaining the arrangement and of bonding the substrate to the display panel while spreading the adhesive by the bonding surfaces.

2. The method of manufacturing a display device according to claim 1,
wherein the display panel is composed of an arrangement panel formed by arranging a plurality of display elements in plan view, and
the substrate is a substrate for supporting the display panel composed of the plurality of display elements.

3. The method of manufacturing a display device according to claim 1,
wherein the display panel includes organic EL elements, each having an organic functional layer including a light emitting layer interposed between a pair of electrodes, and
the substrate is bonded to the display panel by the adhesive so as to cover the upper sides of the organic EL devices.

4. The method of manufacturing a display device according to claim 1,
wherein, when the substrate is bonded to the display panel, the substrate is arranged opposite to the display panel with the bonding surface of the display panel facing upward, and
the substrate is bonded to the display panel by spreading the adhesive by inclining the substrate to the display panel.

5. The method of manufacturing a display device according to claim 4,
wherein, when the substrate is bonded to the display panel, the position of the substrate is restrained in the surface direction thereof at an edge of the substrate in the vicinity of a contact position between the substrate and the display panel.

6. The method of manufacturing a display device according to claim 5,
wherein, when the substrate is bonded to the display panel, the position of the substrate is restrained at the edges of a plurality of sides of the substrate.

7. The method of manufacturing a display device according to claim 4,
wherein, when the substrate is bonded to the display panel, the adhesive is spread by the weight of the substrate.

8. The method of manufacturing a display device according to claim 1,
wherein, when the substrate is bonded to the display panel, air bubbles generated between the substrate and the adhesive or between the display panel and the adhesive are removed by vibrating the substrate or the display panel.

9. A substrate bonding apparatus used for manufacturing a display device including a first substrate and a second substrate opposite to each other with an adhesive layer interposed therebetween, comprising:
substrate fixing means for fixing and holding the first substrate;
substrate supporting means for cantilever-supporting the second substrate in a state in which a bonding surface of the second substrate comes into contact with the edge of one side of the first substrate; and
control means for making the second substrate approach and bond to the first substrate, which is arranged opposite to each other with an adhesive interposed therebetween, by moving the substrate supporting means.

10. The substrate bonding apparatus according to claim 9, further comprising:
adhesive supplying means for applying the adhesive to form the adhesive layer on a bonding surface of the first substrate or the bonding surface of the second substrate.

11. The substrate bonding apparatus according to claim 9,
wherein the substrate supporting means includes supporting rollers for supporting the bonding surface of the second substrate to slide thereon.

12. The substrate bonding apparatus according to claim 10, further comprising:
substrate position restricting means arranged in the vicinity of a position where the second substrate comes into contact with the first substrate for restricting the movement of the second substrate in the surface direction thereof.

13. The substrate bonding apparatus according to claim 9, further comprising:
vibration generating means for vibrating the first substrate or the second substrate.

14. The substrate bonding apparatus according to claim 9, further comprising:
air bubble detecting means provided on an outer surface of the first substrate or the second substrate for detecting air bubbles in the adhesive.

15. The substrate bonding apparatus according to claim 14,
wherein the vibration generating means operates based on air bubble information inputted from the air bubble detecting means.

16. The substrate bonding apparatus according to claim 14,
wherein the substrate supporting means operates based on air bubble information inputted from the air bubble detecting means.
